(19) United States
(12) Patent Application Publication
(10) Pub. No.: US 2020/0395635 A1
(43) Pub. Date: Dec. 17, 2020

(54) BATTERY PACK AND ASSEMBLY OF BATTERY PACK AND POWER TOOL

(71) Applicant: Nanjing Chervon Industry Co., Ltd., Nanjing (CN)

(72) Inventor: Min Zhang, Nanjing (CN)

(21) Appl. No.: 16/897,397

(22) Filed: Jun. 10, 2020

(30) Foreign Application Priority Data
Jun. 11, 2019 (CN) 201910501978.9

(51) Int. Cl. H01M 10/42; H01M 2/30

(52) U.S. Cl. CPC H01M 10/4257; H02J 7/0063; H01M 2/30

(57) ABSTRACT

A battery pack is detachably mountable to a power tool. The power tool includes a positive connection terminal, a negative connection terminal and a tool communication terminal. The battery pack includes a housing, a cell group, a positive power supply terminal, a negative power supply terminal, and a battery pack communication terminal. The battery pack is connected to the power tool in an installation direction. The battery pack communication terminal includes a first connection portion which is in contact connection to an upper portion of the tool communication terminal, and a second connection portion which is in contact connection to a lower portion of the tool communication terminal. The first and the second connection portion are staggered in the installation direction.

### RELATED APPLICATION INFORMATION

The present application claims the benefit of CN 201910501978.9, filed on Jun. 11, 2019, the disclosure of which is incorporated herein by reference in its entirety.

### TECHNICAL FIELD

The present disclosure relates to a battery pack and in particular, to a battery pack applicable to a power tool and an assembly of the battery pack and the power tool which is able to improve communication efficiency there between in vibration conditions.

### BACKGROUND

With the convenience of using a cordless power tool, power tools powered by battery packs are also becoming more and more widely used.

During the cooperation work of the battery pack with the power tool, vibration always exists, and the vibration frequency and period are different. Due to constraints such as shape, platform, and plug force, the communication terminal of the battery pack needs to be designed in a limited space to have a not-too-large plug force while ensuring uninterrupted communication and good wear resistance.

Due to existence of vibration during the use of the power tool, the communication terminal of the existing battery pack and the communication terminal of the power tool have a risk of contact failure at a contact position, which may result in repeated communication or communication failure.

### SUMMARY

The present disclosure provides, as an example, a battery pack, applicable to a power tool, where the battery pack is detachably mounted to the power tool. The power tool includes a positive connection terminal, a negative connection terminal, and a tool communication terminal. The battery pack includes a housing, a cell group, a positive power supply terminal, a negative power supply terminal and a battery pack communication terminal. The connection interface is formed in at least part of the housing to connect the battery pack to the power tool. The battery pack is able to be connected to the power tool in an installation direction. The cell group is accommodated in the housing and includes a plurality of cells, and the plurality cells are electrically connected to the cell group. The positive power supply terminal is connected to a positive electrode of the cell group and used for connecting to the positive connection terminal of the power tool. The negative power supply terminal is connected to a negative electrode of the cell group and used for connecting to the negative connection terminal of the power tool. The battery pack communication terminal is used for connecting to a tool communication terminal of the power tool to establish a communication connection between the battery pack and the power tool. The battery pack communication terminal includes a first connection portion which is in contact connection to an upper portion of the tool communication terminal of the power tool, and a second connection portion which is in contact connection to a lower portion of the tool communication terminal of the power tool. The first connection portion and the second connection portion are staggered in the installation direction.

Optionally, the first connection portion and the second connection portion are provided to have different lengths in the installation direction.

Optionally, a length difference of the first connection portion and the second connection portion ranges from 2 mm to 5 mm in the installation direction.

Optionally, a length of the first connection portion is greater than a length of the second connection portion in the installation direction.

Optionally, a length of the first connection portion is less than a length of the second connection portion in the installation direction.

Optionally, the first connection portion is in contact with an upper portion of the tool communication terminal at a first contact position, the second connection portion is in contact with a lower portion of the tool communication terminal at a second contact position, and the first contact position and the second contact position are staggered from each other in the installation direction.

Optionally, a distance between the first contact position and the second contact position in the installation direction is 2 mm to 5 mm.

Optionally, the present disclosure further provides a battery pack communication terminal disposed on a battery pack, where the battery pack is applicable to a power tool, the battery pack is able to be connected to the power tool in an installation direction, and the power tool has a tool communication terminal. A communication terminal of the battery pack includes a first connection portion which is in contact connection to an upper portion of the tool communication terminal of the power tool, and a second connection portion which is in contact connection to a lower portion of the tool communication terminal of the power tool. The first connection portion and the second connection portion are provided to have different lengths in the installation direction.

Optionally, a length difference of the first connection portion and the second connection portion ranges from 2 mm to 5 mm in the installation direction. The present disclosure also provides, as an example, an assembly of a battery pack and a power tool. The battery pack is detachably mounted to the power tool, and the assembly of the battery pack and the power tool includes the power tool and the battery pack. The power tool includes a positive connection terminal, a negative connection terminal, and a tool communication terminal. The battery pack includes a housing, a cell group, a positive power supply terminal, a negative power supply terminal and a battery pack communication terminal. A connection interface is formed in at least part of the housing to connect the battery pack to the power tool. The battery pack is able to be connected to the power tool in an installation direction. The cell group is accommodated in the housing and includes a plurality of cells, and the plurality cells are electrically connected to the cell group. The positive power supply terminal is connected to a positive electrode of the cell group and used for connecting to the positive connection terminal of the power tool. The negative power supply terminal is connected to a negative electrode of the cell group and used for connecting to the negative connection terminal of the power tool. The battery pack communication terminal is used for connecting to a tool communication terminal of the power tool to establish a communication connection between the battery pack and the power tool.

The battery pack communication terminal includes a first connection portion which is in contact connection to an upper portion of the tool communication terminal of the power tool, and a second connection portion which is in contact connection to a lower portion of the tool communication terminal of the power tool. The first connection portion and the second connection portion are provided to have different lengths in the installation direction.

### BRIEF DESCRIPTION OF DRAWINGS

FIG. 1 is an external view of a battery pack according to an example.

FIG. 2 is an external view from different viewing angles of the battery pack shown in FIG

FIG. 3 is a partial internal structure view of the battery pack shown in FIG. 1 after removing a housing.

FIG. 4 is an internal structure view from different viewing angles of the battery pack shown in FIG. 3 after removing the housing.

FIG. 5 is an exploded view of the battery pack shown in FIG. 3.

FIG. 6 is a perspective view of a battery pack communication terminal according to an example.

FIG. 7 is a plan view from another perspective of the battery pack communication terminal shown in FIG. 6.

FIG. 8 is a plan view from still another perspective of the battery pack communication terminal shown in FIG. 6.

FIG. 9 is a plan view from different viewing angles of the battery pack communication terminal shown in FIG. 6.

FIG. 10 is a plan view of terminals of the battery pack provided on a circuit board.

FIG. 11 is a schematic view illustrating a contact connection between a battery pack communication terminal and a tool communication terminal.

FIG. 12 is a structure view of a battery pack mounted on a power tool according to an example.

FIG. 13 is a schematic circuit diagram of an assembly of the battery pack and the power tool shown in FIG. 12.

### DETAILED DESCRIPTION

The present disclosure will be described below in detail in conjunction with the drawings and examples.

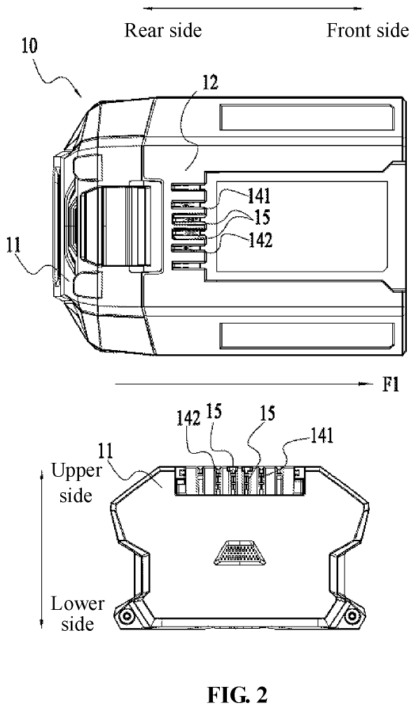

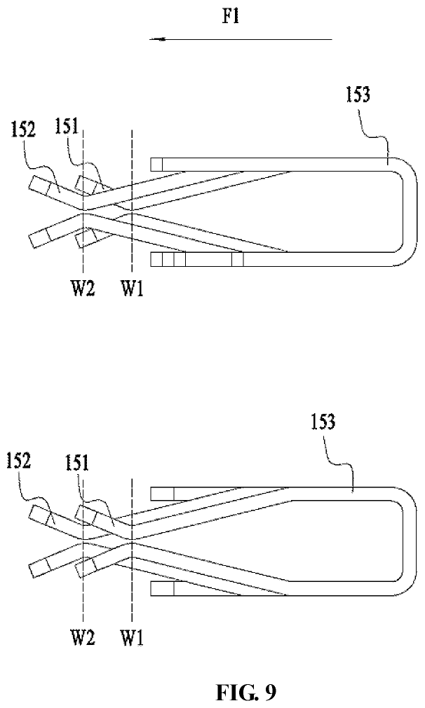

For the convenience of explanation, the present disclosure defines a “front side”, a “rear side”, an “upper side” and a “lower side” as shown in FIGS. 2, 7 to 9. It can be understood that the “front side”, “rear side”, “upper side”, “lower side”, “left side”, and “right side” are only convenience words, not restrictive terms.

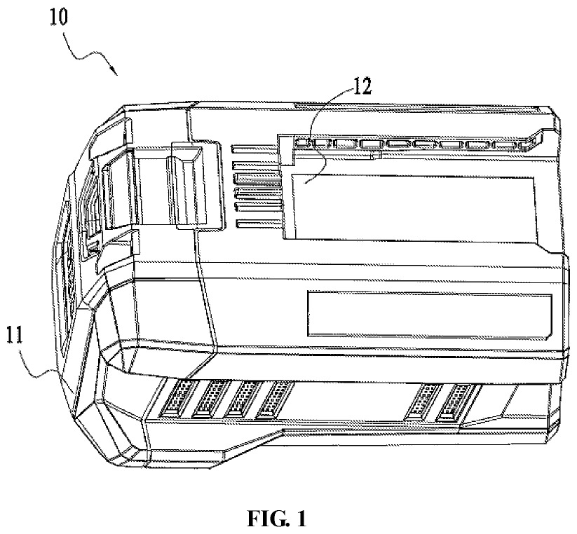

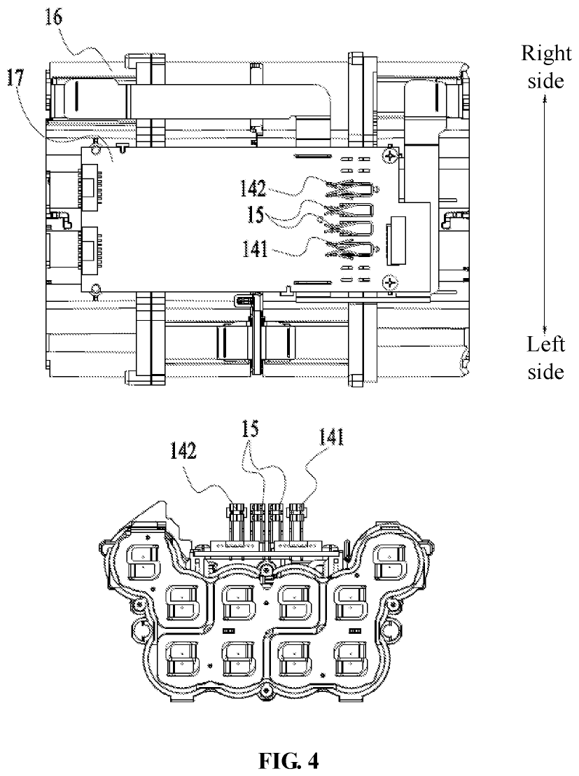

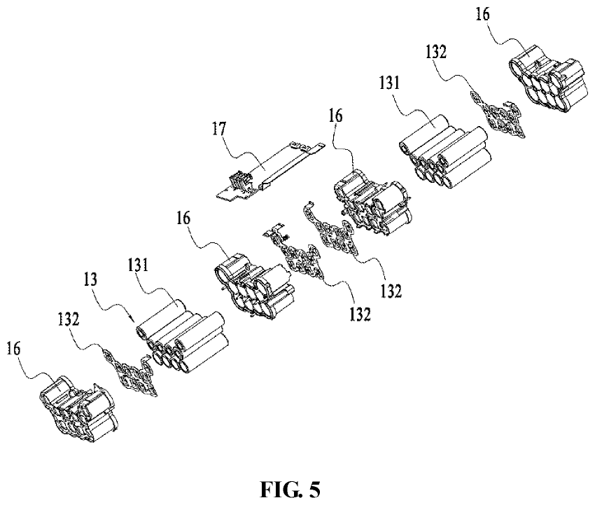

Referring to FIGS. 1 to 5, a battery pack 10 according to an example includes: a housing 11, a connection interface 12, a cell group 13, a power supply terminal 14 and a battery pack communication terminal 15.

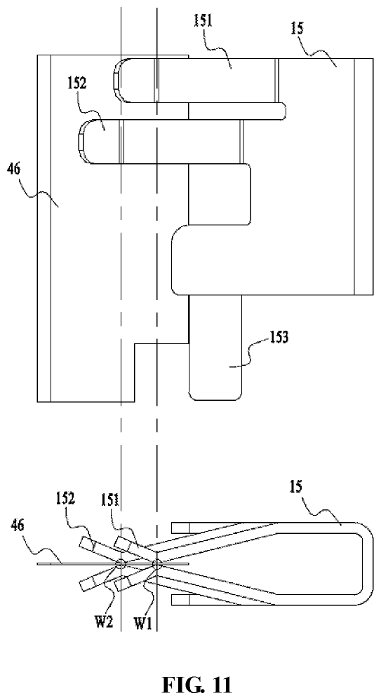

The housing 11 at least partially forms an outer surface of the battery pack 10, and the housing 11 is at least used for accommodating the cell group 13. The housing 11 is at least partially formed with the connection interface 12 for connecting the battery pack 10 to the power tool 20 (FIG. 11). The battery pack 20 can be connected to the power tool 20 along an installation direction F1 (FIG. 11). The battery pack 10 serves as an energy source for the power tool 20 to provide power for the power tool 20.

A cell group 13 is accommodated in the housing 11, the cell group 13 includes multiple cells 131, and the multiple cells 131 are electrically connected to form the cell group 13. Specifically, the multiple battery cells 131 are electrically connected through a conductive sheet 132. Optionally, the battery pack 10 further includes a bracket 16 which is disposed in the housing 11 to support the cell group 13.

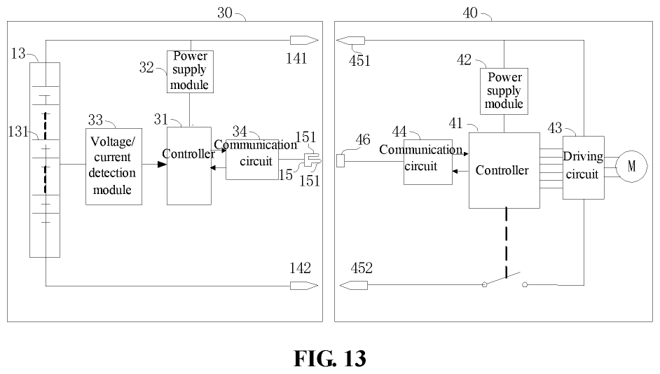

The power supply terminal 14 includes a positive power supply terminal 141 and a negative power supply terminal 142, the positive power supply terminal 141 is connected to a positive electrode of the cell group 13, and the negative power supply terminal 142 is connected to a negative electrode of the cell group 13. The positive power supply terminal 141 and the negative power supply terminal 142 are used for contact connection to connection terminals of an external device to realize an electrical connection between the battery pack 20 and the external device. Optionally, the external device includes, but is not limited to, the power tool 20. The positive power supply terminal 141 is used for connecting to a positive connection terminal 451 (FIG. 13) of the power tool 10, a negative device is used for connecting to a negative connection terminal 452 of the power tool 10 (FIG. 13), and the positive power supply terminal 141 and the negative power supply terminal 142 are used for enabling the battery pack 10 to transmit power to the external device.

In this example, the battery pack 10 further includes a battery pack communication terminal 15 for connecting to a tool communication terminal 46 (FIG. 13) of the power tool 10 to establish a communication connection between the battery pack 10 and the power tool 20. In this way, the battery pack 10 and the power tool 20 are able to achieve data communication.

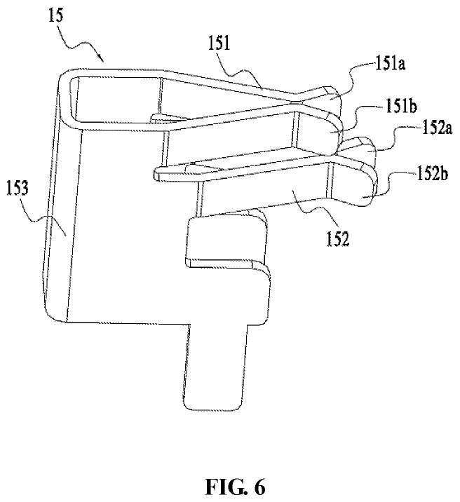

Referring to FIGS. 6 to 9, the battery pack communication terminal 15 includes a first connection portion 151 and a second connection portion 152. The first connection portion 151 is in contact connection to an upper portion of the tool communication terminal 46 of the power tool 20, and the second connection portion 152 is in contact connection to a lower portion of the tool communication terminal 46 of the electric tool 10. The first connection portion 151 and the second connection portion 152 are connected to each other or integrally formed by a support portion 153. The first connection portion 151 and the second connection portion 152 are arranged from up to down. The first connection portion 151, the second connection portion 152 and the support portion 153 are connected to each other or integrally formed. Optionally, the first connection portion 151, the second connection portion 152 and the support portion 153 are made of a conductive material. Optionally, the support portion 153 is also used for fixedly mounting the battery pack communication terminal 15 to a circuit board 17. The circuit board 17 is accommodated in the housing 11, and electronic components are provided on the circuit board 17 to enable normal operation of the battery pack 10.

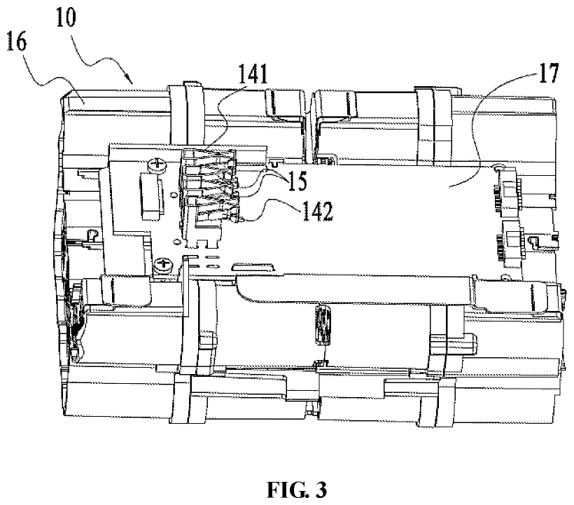

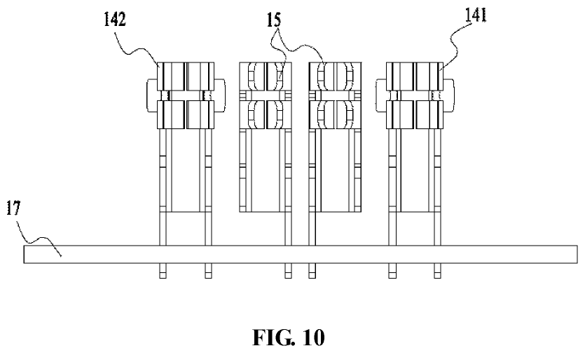

Referring to FIGS. 3, 4 and 10, the positive power supply terminal 141, the negative power supply terminal 142, and the battery pack communication terminal 15 of the battery pack 10 are arranged substantially parallel to each other in a left-right direction on the circuit board 17.

Referring to FIG. 11, optionally, the tool communication terminal 46 is provided in a flat plate shape. The battery pack communication terminal 15 is provided to be able to hold the tool communication terminal 46 so that the tool communication terminal 46 can be connected to the battery pack communication terminal 15.

Optionally, the battery pack communication terminal 15 is provided such that the first connection portion 151 is configured to include two halves, i.e., a first half 151a and a second half 151b in a tulip shape. Such configuration enables the tool communication terminal 46 to be held.

Similarly, the second connection portion 152 is configured to include two halves, i.e., a first half 152a and a second half 152b in a tulip shape.

In this example, the first connection portion 151 and the second connection portion 152 are provided to have different lengths in the installation direction F1. The installation direction F1 is a direction in which the battery pack 10 is able to be mounted to the power tool 20. In this example, the installation direction Fl is a direction in which openings of the first half 151a and the second half 151b of the battery pack communication terminal 15 face, or a direction in which the battery pack communication terminal 15 receives the tool communication terminal 46, or is a direction in which the power tool 20 receives the battery pack 10.

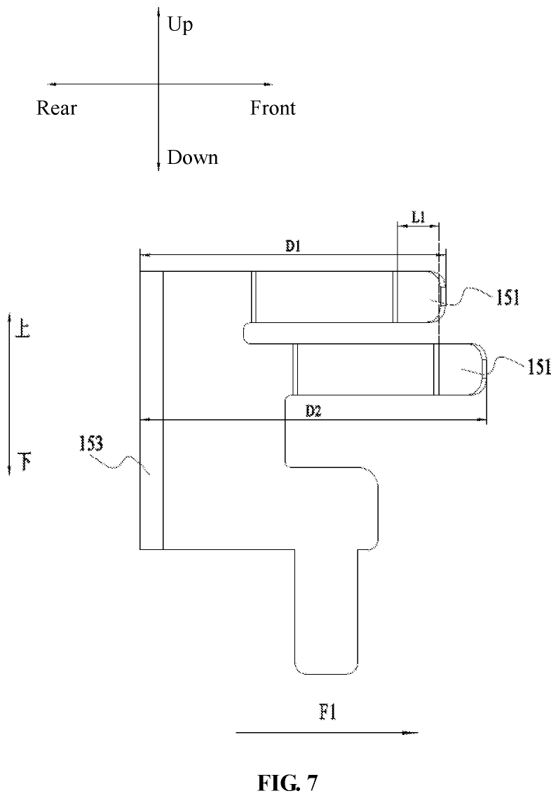

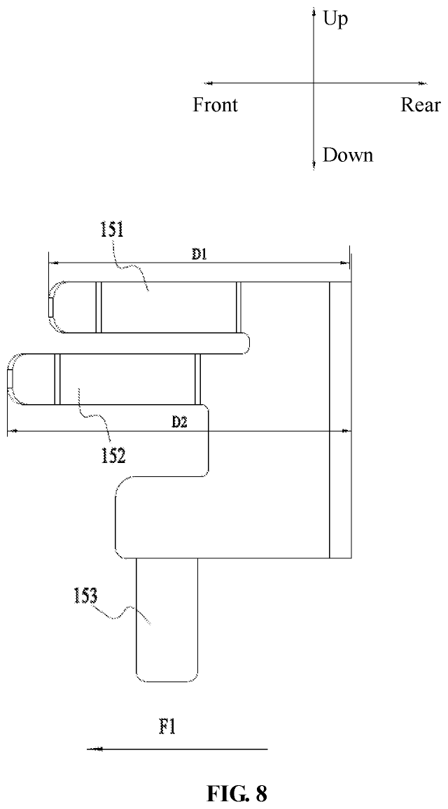

Referring to FIGS. 7 and 8, for convenience of description, the opening direction of the battery pack communication terminal 15 is defined as a “front side” of the battery pack 10, and an opposite side of the “front side” is defined as a “rear side” of the battery pack 10. A direction where the first connection portion 151 is located relative to the second connection portion 152 is defined as an “upper side” of the battery pack, namely, the first connection portion 151 is located on the “upper side” of the second connection portion 152. A direction where the second connection portion 152 is located relative to the first connection portion 151 is defined as a “lower side” of the battery pack, namely, the second connection portion 152 is located on the “lower side” of the first connection portion 151. According to the above definition, the installation direction F1 extends from the “rear side” to the “front side”.

In this example, the first connection portion 151 and the second connection portion 152 are staggered in the installation direction F1.

Specifically, in the installation direction F1, the first connection portion 151 is in contact with the upper portion of the tool communication terminal at a first contact position W1, and the second connection portion 152 is in contact with the lower portion of the tool communication terminal at a second contact position W2, where the first contact position W1 and the second contact position W2 are staggered from each other in the installation direction F1. The advantage is that after the battery pack communication terminal 151 is connected to the tool communication terminal 46 of the power tool 20, the power tool 20 may vibrate during operation, causing vibration of the battery pack communication terminal 15 and the tool communication terminal 46. The battery pack communication terminal 15 in this example is provided such that vibration transmission points are presented from being on a same line in an up-down direction, thereby reducing unnecessary repeated communication due to intermittent contact between the battery pack communication terminal 15 and the tool communication terminal 46, and improving communication efficiency.

Optionally, the first connection portion 151 and the second connection portion 152 are provided to have different lengths so that the first connection portion 151 and the second connection portion 152 are staggered in the installation direction F1. Specifically, referring to FIGS. 7 and 8, with a rear surface of the support portion 153 as a reference point, the first connection portion 151 has a first length D1 and the second connection portion 152 has a second length D2. The first length D1 and the second length D2 are different.

Optionally, a length difference between the first length D1 and the second length D2 ranges from 2 mm to 5 mm, namely, the length difference between the first connection portion 151 and the second connection portion 152 in the installation direction Fl ranges from 2 mm to 5 mm. such staggered distance can make use of a phase difference of vibration transmission so that communication interruption, caused by the separation of both the first connection portion 151 and the second connection portion 152 in the battery pack communication terminal 15 from the tool communication terminal 46 due to the resonance, will not occur at any time. That is, at any time, at least one of the first connection portion 151 and the second connection portion 152 is in contact with the tool communication terminal 46. Such configuration enables reduction of unnecessary repeated communication and improvement of communication efficiency.

According to an example, a length of the first connection portion 151 is greater than a length of the second connection portion 152 in the installation direction F1, namely, the first length D1 is greater than the second length D2. According to another example, a length of the first connection portion 151 in the installation direction F1 is less than a length of the second connection portion 152, namely, the first length D1 is less than the second length D2. Optionally, the first contact position W1 of the first connection portion 151 and the tool communication terminal 46, and the second contact position W2 of the second connection portion 152 and the tool communication terminal 46 are provided to be staggered from each other in the installation direction F1. Specifically, referring to FIG. 11, the tool communication terminal 46 may be optionally in a flat shape. When the battery pack 10 is connected to the power tool 20, the first connection portion 151 and the tool communication terminal 46 are in contact connection at the first contact position W1, and the second connection portion 152 and the tool communication terminal 46 are in contact connection at the second contact position W2. The first contact position W1 is located on the upper side, the second contact position W2 is located on the lower side, and the first contact position W1 and the second contact position W2 are staggered from each other in the installation direction F1.

Optionally, a staggered distance between the first contact position W1 and the second contact position W2 in the installation direction F1 ranges from 2 mm to 5 mm. Such staggered distance can make use of a phase difference of vibration transmission so that communication interruption, caused by the separation of both the first connection portion 151 and the second connection portion 152 from the tool communication terminal 46 due to the resonance, will not occur at any time. That is, at any time, at least one of the first connection portion 151 and the second connection portion 152 is in contact with the tool communication terminal 46. Such configuration enables reduction of unnecessary repeated communication and improvement of communication efficiency.

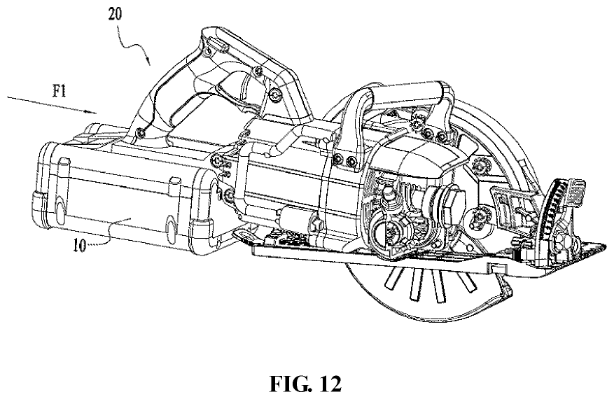

Referring to FIGS. 12 to 13, according to an example, an assembly of a battery pack 10 and a power tool 20 is provided, where the battery pack 10 is provided according to the above example, the battery pack 10 is applicable to the power tool 20, and the battery pack 10 is detachably installed to the power tool 20 to power the power tool 20.

FIG. 13 is a circuit system of the battery pack 10 and the power tool 20, the battery pack 10 includes a battery pack circuit system 30, and the power tool 20 includes a power tool circuit system 40.

The power tool 20 includes the positive connection terminal 451, the negative connection terminal 452, and the tool communication terminal 46. The battery pack 10 includes a housing 11, a cell group 13, a positive power supply terminal 141, a negative power supply terminal 142 and a battery pack communication terminal 15. A connection interface 12 is formed in at least part of the housing to connect the battery pack 10 to the power tool 20. The battery pack 10 is able to be connected to the power tool 20 in an installation direction. The cell group 13 is accommodated in the housing 11 and includes multiple cells 131, and the multiple cells 131 are electrically connected to the cell group 13. The positive power supply terminal 141 is connected to a positive electrode of the cell group 12, and used for connecting to the positive connection terminal 451 of the power tool 10. The negative power supply terminal 142 is connected to a negative electrode of the cell group 13 and used for connecting to the negative connection terminal 452 of the power tool 20. The battery pack communication terminal 15 is used for connecting to a tool communication terminal 46 of the power tool 20 to establish a communication connection between the battery pack 10 and the power tool 20.

The battery pack communication terminal 15 includes a first connection portion 151 which is in contact connection to an upper portion of the tool communication terminal 46 of the power tool 20, and a second connection portion 152 which is in contact connection to a lower portion of the tool communication terminal 46 of the power tool 20. The first connection portion 151 and the second connection portion 152 are provided to have different lengths in the installation direction F1.

The battery pack communication terminal 15 is the same as that in the above example, and will not be repeated here. The battery pack further includes a controller 31, a power supply module 32, a voltage/current detection module 33, and a communication circuit 34.

The voltage/current detection module 33 is connected to the cell group 13 or the single cell 131 to detect a voltage of the cell group 13 or the single cell 131. The voltage/current detection module 33 is routine in the field, and will not be repeated here.

The controller 31 is connected to the voltage/current detection module 33 and controls an operation process of the battery pack 10 according to a detection signal of the voltage/current detection module 33. For example, after receiving a detection signal including an abnormal state of the battery pack (for example, under voltage) of the voltage/current detection module 33, the controller 31 outputs a signal to the communication circuit 34. Then, the signal is outputted to the power tool 20 through the communication circuit 34. After receiving the signal sent from the battery pack 10 through a tool communication circuit 44, a controller 41 of the power tool 20 controls an electronic switch to disconnect a driving circuit 43, thereby stopping the motor driving.

The power supply module 32 is connected to the controller 31 to provide power to the controller 31. The power supply module 32 is also connected to the cell group 13 to convert the electric energy of the battery group 13 into electric energy that can be used by the controller 31.

The communication circuit 34 is connected to the controller 31 to transmit the signal of the controller 31 to the power tool 20.

The power tool 20 includes the communication circuit 44, the controller 41, the power supply module 42 and the driving circuit 43. The above electronic components and the motor drive system 40 of the power tool 20 are well known to those skilled in the art, and will not be repeated here.

The controller 31 of the battery pack 10 outputs a signal to the power tool 20 through the communication circuit 34 connected to the controller 31 according to a signal of the voltage/current detection module 33, and the control module 41 of the power tool 20 receives the signal sent from the battery pack 10 through the communication circuit 34 and performs corresponding processing. In this process, the battery pack communication terminal 15 is in contact connection to the tool communication terminal 46 of the power tool 20. Since the first connection portion 151 and the second connection portion 152 of the battery pack communication terminal 15 are staggered from each other in the installation direction F1, even if the power tool 10 vibrates and affects the contact stability of the battery pack communication terminal 15 and the tool communication terminal 46, vibration transmission points can be presented from being on a same line in the up-down direction, thereby reducing unnecessary repeated communication due to intermittent contact between the battery pack communication terminal 15 and the tool communication terminal 46, and improving communication efficiency. Further, the first connection portion 151 and the second connection portion 152 are staggered from each other in the installation direction F1 by ranging from 2 mm to 5 mm, and the first connection portion 151 and the second connection portion 152 can make use of a phase difference of vibration transmission so that communication interruption, caused by the separation of both the first connection portion 151 and the second connection portion 152 from the tool communication terminal 46 due to the resonance, will not occur at any time. That is, at any time, at least one of the first connection portion 151 and the second connection portion 152 is in contact with the tool communication terminal 46. Such configuration enables reduction of unnecessary repeated communication and improvement of communication efficiency.

The present disclosure also discloses a battery pack communication terminal. The battery pack communication terminal is the same as or similar to the battery pack communication terminal 15 in the above example, and will not be repeated here.

The above illustrates and describes basic principles, main features and advantages of the present disclosure. It is to be understood by those skilled in the art that the above examples do not limit the present disclosure in any form, and solutions obtained by means of equivalent substitution or equivalent transformation fall within the scope of the present disclosure.

What is claimed is:

1. A battery pack applicable to a power tool, wherein the battery pack is detachably mounted to the power tool, the power tool comprises a positive connection terminal, a negative connection terminal, and a tool communication terminal, and the battery pack comprises:
a housing, wherein a connection interface is formed in at least part of the housing to connect the battery pack to the power tool; and the battery pack is able to be connected to the power tool in an installation direction;
a cell group accommodated in the housing, the cell group comprising a plurality of cells, and the plurality of cells being electrically connected to form the cell group;
a positive power supply terminal connected to a positive electrode of the cell group and for connecting to the positive connection terminal of the power tool;
a negative power supply terminal connected to a negative electrode of the cell group and for connecting to the negative connection terminal of the power tool; and
a battery pack communication terminal for connecting to the tool communication terminal of the power tool to establish a communication connection between the battery pack and the power tool;
wherein the battery pack communication terminal comprises:
a first connection portion, which is in contact connection to an upper portion of the tool communication terminal of the power tool; and
a second connection portion, which is in contact connection to a lower portion of the tool communication terminal of the power tool; and
wherein the first connection portion and the second connection portion are staggered in the installation direction.

2. The battery pack of claim 1, wherein the first connection portion and the second connection portion are configured to have different lengths in the installation direction.

3. The battery pack of claim 1, wherein a length difference of the first connection portion and the second connection portion ranges from 2 mm to 5 mm in the installation direction.

4. The battery pack of claim 1, wherein a length of the first connection portion is greater than a length of the second connection portion in the installation direction.

5. The battery pack of claim 1, wherein a length of the first connection portion is less than a length of the second connection portion in the installation direction.

6. The battery pack of claim 1, wherein the first connection portion is in contact with the upper portion of the tool communication terminal at a first contact position, the second connection portion is in contact with the lower portion of the tool communication terminal at a second contact position, and the first contact position and the second contact position are staggered from each other in the installation direction.

7. The battery pack of claim 1, wherein a distance between the first contact position and the second contact position in the installation direction is 2 mm to 5 mm.

8. A battery pack communication terminal disposed on a battery pack, wherein the battery pack is applicable to a power tool, the battery pack is able to be connected to the power tool in an installation direction, the power tool has a tool communication terminal, and the battery pack communication terminal comprises:
a first connection portion, which is in contact connection to an upper portion of the tool communication terminal of the power tool; and
a second connection portion, which is in contact connection to a lower portion of the tool communication terminal of the power tool,
wherein the first connection portion and the second connection portion are provided to have different lengths in the installation direction.

9. The battery pack communication terminal of claim 8, wherein a length difference of the first connection portion and the second connection portion ranges from 2 mm to 5 mm in the installation direction.

10. A system, comprising:
a power tool, which comprises a positive connection terminal, a negative connection terminal, and a tool communication terminal; and
the battery pack, which comprises:
a housing, wherein a connection interface is formed in at least part of the housing for detachably connecting the battery pack to the power tool and the battery pack is able to be connected to the power tool in an installation direction;
a cell group accommodated in the housing, the cell group comprising a plurality of cells, and the plurality of cells being electrically connected to form the cell group;
a positive power supply terminal connected to a positive electrode of the cell group and for connecting to the positive connection terminal of the power tool;
a negative power supply terminal connected to a negative electrode of the cell group and for connecting to the negative connection terminal of the power tool; and
a battery pack communication terminal for connecting to the tool communication terminal of the power tool to establish a communication connection between the battery pack and the power tool;
wherein the battery pack communication terminal comprises:
a first connection portion, which is in contact connection to an upper portion of the tool communication terminal of the power tool; and
a second connection portion, which is in contact connection to a lower portion of the tool communication terminal of the power tool; and
wherein the first connection portion and the second connection portion are provided to have different lengths in the installation direction.
